(19) United States
(12) Patent Application Publication
(10) Pub. No.: US 2025/0118783 A1
(43) Pub. Date: Apr. 10, 2025

(54) Pressurized Steam Reversible High Temperature Proton Exchange Membrane Hydrogen Fuel Cell System

(71) Applicant: HyWatts Inc., Wilmington, DE (US)

(72) Inventors: Aleksei Ivanenko, Danville, CA (US); Dietmar Trees, San Diego, CA (US); Artem Riazantsev, San Diego, CA (US); Alexander Todorov, Puerto de la Cruz (ES); Samuel Emil Ruben, Sausalito, CA (US)

(21) Appl. No.: 18/907,776

(22) Filed: Oct. 7, 2024

Related U.S. Application Data
(60) Provisional application No. 63/542,958, filed on Oct. 6, 2023.
(60) Provisional application No. 63/542,963, filed on Oct. 6, 2023.

(51) Int. Cl. H01M 8/0656; H01M 8/04029

(52) U.S. Cl. CPC H01M 8/0656; H01M 8/04029

(57) ABSTRACT

A reversible high temperature proton exchange membrane (HTPEM) fuel cell energy production and storage system includes an electrolysis mode and a fuel cell mode. The system operates at elevated temperatures (e.g., 130° C. to 270° C.) and, in an electrolysis mode, converts water vapor to hydrogen. The electrolysis occurs more energy efficiently at higher temperatures as reaction potentials decline and ionic conductivity increases. In addition, when water is in a gaseous state, oxygen removal from the anode is facilitated which improves the reaction kinetics. Coolant is circulated between the stack and a heat exchanger to use excess heat from the stack generated in electrolysis mode to heat water for further electrolysis. Components and subsystems may be powered by electricity generated during fuel cell mode. A series of heat exchangers, pumps, storage tanks, and compressors allow the system to capture efficiencies in both modes of operation.

### RELATED APPLICATION DATA

This application claims the benefit of priority of U.S. Provisional Patent Application Ser. No. 63/542,958, filed Oct. 6, 2023, and titled Pressurized Steam Hydrogen and Power Production System Based on a Reversible HTPEM Fuel Cell and Method of Operation Thereof, and U.S. Provisional Patent Application Ser. No. 63/542,963, filed Oct. 6, 2023, and titled Membrane Electrode Assembly Structure for High Temperature PEM Fuel Cells and Water Electrolysis, which are incorporated by reference herein in their entirety.

This application is related to U.S. Non-provisional patent application Ser. No. 18/907,535, filed on Oct. 6, 2024, and titled Membrane Electrode Assembly Structure for High Temperature PEM Fuel Cells and Water Electrolysis.

### FIELD OF THE DISCLOSURE

The present disclosure generally relates to the field of reversible fuel cell systems. In particular, the present disclosure is directed to a pressurized steam reversible high temperature proton exchange membrane (HTPEM) hydrogen fuel cell system.

### BACKGROUND

Reversible electrolyzer/fuel cell systems can be used for storing energy via hydrogen production through electrolysis and for generating electric energy from the stored hydrogen. These systems could be used for storing energy produced by renewable, intermittent power sources, such as wind and solar. However, high costs have been a limiting factor for reversible electrolyzer/fuel cell systems.

### SUMMARY OF THE DISCLOSURE

A reversible high temperature proton exchange membrane (HTPEM) system having an electrolysis mode and a fuel cell mode includes an HTPEM reversible fuel cell stack, a water pump connected to a water supply, wherein the water pump is configured to pressurize liquid water, a first heat exchanger connected to the water pump and the HTPEM reversible fuel cell stack, a coolant pump connected to a coolant line, wherein the coolant line loops through the first heat exchanger and the HTPEM reversible fuel cell stack such that, in the electrolysis mode, heat produced in the HTPEM reversible fuel cell stack is transferred to the pressurized liquid water to generate pressurized steam that is supplied to an anode of the HTPEM reversible fuel cell stack, a second heat exchanger connected to a cathode outlet of the HTPEM reversible fuel cell stack, wherein the second heat exchanger is configured to cool pressurized hydrogen, a first compressor connected to the second heat exchanger, wherein the first compressor is configured to further compress hydrogen received from the second heat exchanger, a hydrogen storage tank connected to the first compressor and to the HTPEM reversible fuel cell stack, a third heat exchanger connected to an anode outlet of the HTPEM reversible fuel cell stack, wherein the third heat exchanger is configured to cool oxygen and water vapor, a water separator connected to the third heat exchanger configured to condense the water vapor received from the third heat exchanger, a fourth heat exchanger connected to the water separator, wherein the fourth heat exchanger is configured to cool oxygen received from the water separator, a second compressor connected to the fourth heat exchanger configured to compress oxygen received from the fourth heat exchanger, and an oxygen storage tank connected to the second compressor, wherein the oxygen storage tank is connected to the HTPEM reversible fuel cell stack.

### BRIEF DESCRIPTION OF THE DRAWINGS

For the purpose of illustrating the disclosure, the drawings show aspects of one or more embodiments of the disclosure. However, it should be understood that the present disclosure is not limited to the precise arrangements and instrumentalities shown in the drawings, wherein:

FIG. 1 is a schematic diagram showing components of a reversible HTPEM system in electrolyzer mode in accordance with an embodiment of the present disclosure;

FIG. 2 is a schematic diagram showing components of the reversible HTPEM system of FIG. 1 in fuel cell mode;

FIG. 3 is a schematic diagram showing components of a reversible HTPEM system in electrolyzer mode in accordance with another embodiment of the present disclosure; and

FIG. 4 is a schematic diagram showing components of the reversible HTPEM system of FIG. 3 in fuel cell mode.

### DETAILED DESCRIPTION

By increasing hydrogen and electric power generation in a reversible HTPEM fuel cell system without scaling of fuel cell/electrolyzer stacks, a more cost effective fuel cell/electrolyzer energy storage system is provided. In addition, the cost of the water treatment portion of electrolysis can be reduced as described below, which further increases cost effectiveness of the energy production/storage system.

In an embodiment, an electrolyzer/fuel cell energy storage system operates at elevated temperatures (e.g., 130° C. to 270° C.) and, in an electrolysis mode, converts pressurized water vapor to hydrogen via electrolysis. The electrolysis performed in this mode requires an electrolyzer that includes electrodes, a cathode and an anode, which are separated by an ion-conductive electrolyte. The electrolysis occurs more energy efficiently at higher temperatures as reaction potentials decline and ionic conductivity increases. In addition, because water is in a gaseous state at these elevated temperatures, oxygen (one of the reaction products) removal from the anode is facilitated and, therefore, the reaction kinetics become more favorable.

Water vapor is used as the reactant for the proton exchange membrane in electrolysis mode. Sufficient temperatures and appropriate pressures are required to form the water vapor. The electrolysis is driven by electric power, which is consumed for pressurization and water evaporation initially and then for driving the electrochemical reactions of oxygen evolution and hydrogen reduction. After being evaporated, the water is converted to hydrogen and oxygen with the release of heat due to the intrinsic ohmic resistivity and overpotentials of the electrochemical reactions. This heat is used then to evaporate liquid water for further operation, i.e., additional electrolysis.

The water vapor is pressurized to further facilitate the electrolysis. The liquid water supply for evaporation is maintained at elevated pressures so that the resulting steam can be pressurized at relatively low energy cost.

An increase of the process temperature leads to an exponential increase of the process pressure, minimizing power consumption needed for additional compression to compress the product gases for compressed gas storage. Therefore, generation of the compressed product gases will decrease the energy consumption for additional compression required for product gas storage. However, the increase in hydrogen production rate is the main positive effect of conducting electrolysis with pressurized steam. For example, an increase in steam pressure from 1 bar to 3 bar (abs.) can lead to a more than 50% hydrogen production rate increase from electrolysis in an HTPEM cell.

For cooling, the electrolyzer can utilize the surplus flow of the process water/vapor mixture or can use a separate loop for cooling gas or liquid, connected to a heat exchanger, which can in turn use the excess heat to evaporate or heat the process water/vapor for additional electrolysis.

Water vapor that was not consumed for the reaction can be recycled within the system, further improving the efficiency of the process and reducing water consumption.

The balance of the heat fluxes defined by the parameters of the closed loop of the recirculating water and continuous consumption of the process heat for the generation of the reactant vapor provide for significantly improved overall efficiency of the system.

In an embodiment, a system can be used as a standalone hydrogen generation unit or can be integrated with the hydrogen fuel cell so that the generation of hydrogen, its storage, and its subsequent conversion to electric power are carried out in a single system.

In other embodiments, the integrated electrolyzer and fuel cell system can utilize the reversible fuel cell to support both operating modes by supplying electric power to operate some or all of the components/subsystems, such as fans, compressors, and pumps.

The oxygen generated by electrolysis can be stored and mixed into the air flow during operation of the fuel cell mode.

The system described herein eliminates the need for some of the water treatment components used in current electrolyzer and fuel cell systems For example, there is no need to achieve high purity distilled water, such as ASTM Type IV or higher, because adequate demineralization occurs by evaporating the water. Also, humidification of oxidant and hydrogen flow is not required when the stack includes a membrane electrode assembly designed for such systems, which is described in co-owned U.S. Non-provisional patent application Ser. No. 18/907,535, filed on Oct. 6, 2024, and titled Membrane Electrode Assembly Structure for High Temperature PEM Fuel Cells and Water Electrolysis, which is incorporated by reference herein for its disclosure of said membrane electrode assembly. Finally, there is no need for large input of external water because most of the water (up to 95%) is reused by recirculating it within the system—water is consumed in electrolysis mode and then generated during the fuel cell mode, and unconsumed water during electrolysis is captured for further use in the system.

A system of the present disclosure is applicable for stationary applications for a wide range of power capacities ranging from 5 kW to megawatts and operates with advantages and increased efficiency that include the simplification and cost reduction of the water treatment subsystem, an increase in power output and stack efficiency due to using pressurized steam instead of liquid water in the electrolyzer mode, and an increase in power output and stack efficiency as well as system efficiency in the fuel cell mode due to operation with pressurized reactants. In an embodiment, compressed air is accumulated and stored in the electrolysis mode for use in the fuel cell mode, while in other embodiments compressed air is not accumulated and stored in the electrolysis mode.

### Electrolysis Mode

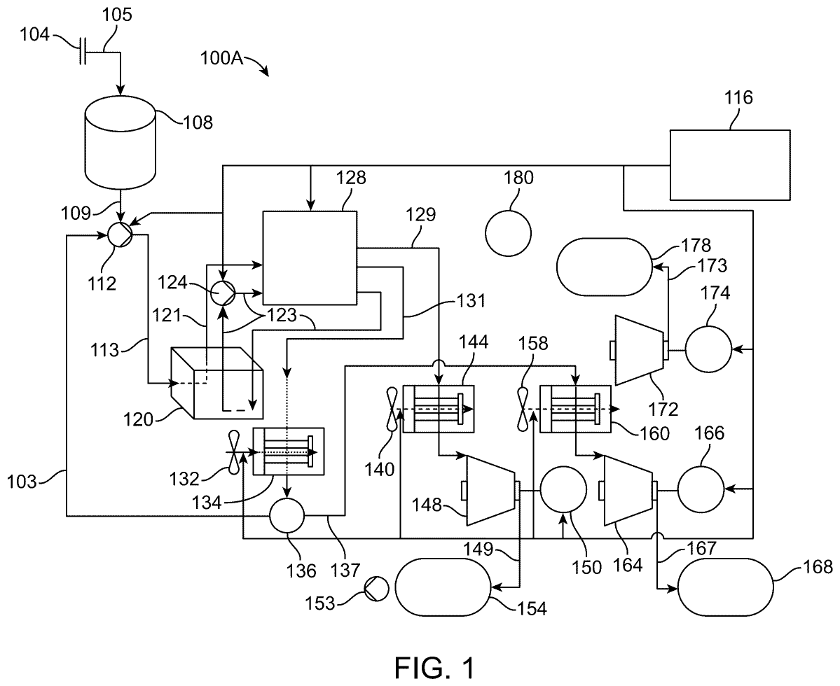

FIG. 1 is a schematic diagram of an HTPEM reversible fuel cell system 100A operating in electrolysis mode. Water source 104 may supply water to water storage tank 108 via line 105. Water is drawn from tank 108 via line 109 into a water pump 112, which generates pressurized liquid water. The water is pressurized up to pressures that are the same as the pressure of the steam input to the stack (higher pressures may be used to compensate for pressure reductions that may occur between the pump and the stack). The pressurized water is supplied to a heat exchanger 120 via line 113, where the pressurized liquid water is converted to pressurized steam by absorbing heat from coolant recirculated via coolant line 123 from a HTPEM reversible stack 128 by a pump 124. When the temperature of the coolant is over 130° C. (as will be the case when the stack is operating in electrolysis mode; at start-up, a separate heat source may be required for a brief period for this evaporation until the stack begins generating heat that is transferred to the coolant), water can be converted to steam at a pressure exceeding 2.5 bar (abs.), for example. This pressurized steam from heat exchanger 120 is supplied to the anode of the HTPEM reversible stack 128 via line 121. HTPEM reversible stack 128 consumes electric power from an electric power source 116 and produces hydrogen at the cathode outlet and a mixture of water vapor and oxygen from anode outlet. Both products are present at that point at the same pressure as the input steam flow.

Pressurized hydrogen exits HTPEM reversible stack 128 via hydrogen line 129 and is cooled down in a gas-to-gas heat exchanger 144 in which air is circulated by a fan 140 and then supplied to a compressor 148 (driven by an electric motor 150) for further compression and then to a hydrogen storage tank 154 via line 149, from which, as described below, it can be used during the fuel cell mode (and therefore may be connected to a gas pressure regulator 153).

The pressurized mixture of water vapor and oxygen exits HTPEM reversible stack 128 via line 131 and is cooled down in another heat exchanger 134 coupled to a fan 132 to a temperature of about 100° C., allowing most of the water vapor to condense (at the pressures of the exhaust). The oxygen is separated from the liquid water in a separator 136. The separated, pressurized oxygen is sent to a heat exchanger 160 coupled to a fan 158 via line 137 where it is further cooled down and then supplied to a compressor 164 (driven by an electric motor 166) for further compression and then to oxygen storage tank 168 via line 167, where it can be used as part of the fuel cell mode described below. The compressed gases may be cooled down in the heat exchangers by means of ambient air supplied by fans (e.g., fans 132, 140, 158).

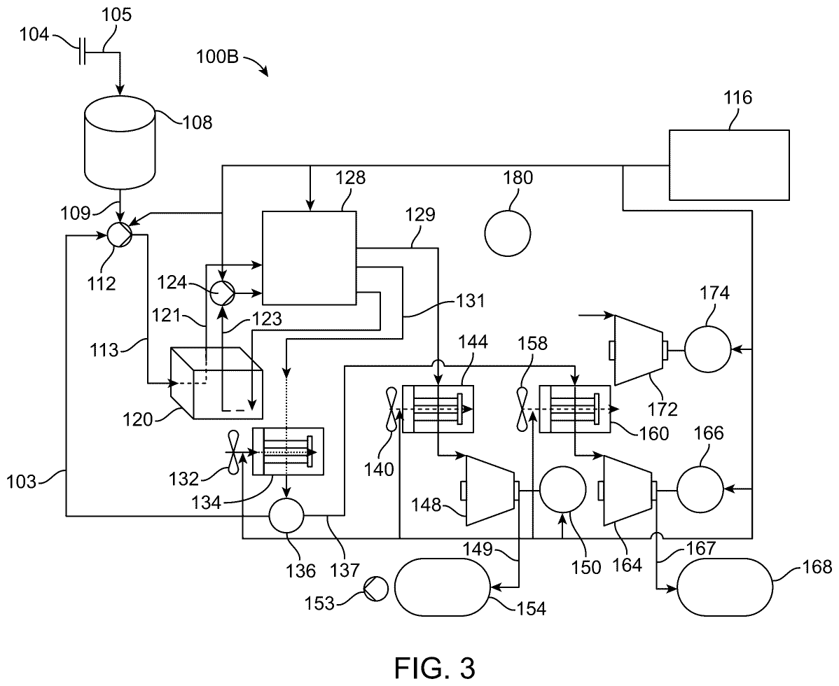

Another compressor 172 driven by an electric motor 174 fills an air holding tank 178 via line 173 with ambient air which can be used in fuel cell mode. Alternatively, no air holding tank is included (as shown for system 100B in FIG. 3) and compressor 172, during fuel cell mode, supplies compressed air to the cathode of the stack via the gas receiver rather than to the air holding tank first.

The hot water separated in the separator 136 is supplied to the inlet of the water pump 112 via line 103. Water for electrolysis in these systems should be clean but does not need to be deionized as for LT PEM and alkaline electrolyzers, because water is supplied to the HTPEM stack in vapor form and thus is distilled by that process.

The external electric power source 116 may supply the HTPEM stack, the three compressors, the three fans, and the two pumps of the system during electrolysis mode. Inverters and other power electronics managing electric power are not shown in the figures for clarity.

Exemplary operating parameters of the system in electrolysis mode include a HTPEM stack efficiency of 60% to 70%, steam flow stoichiometric ratio (determined by the stack 128 and heat exchanger 120 efficiencies) of 2.0 to 3.5, an HTPEM stack operating temperature of 130° C. to 270° C. (and preferably, 140° C. to 200° C.), and steam, hydrogen flow, and oxygen flow absolute pressures (i.e., HTPEM stack operating pressures) of 2 bar to 15 bar (and preferably, 3.0 bar to 5.5 bar).

### Fuel Cell Mode

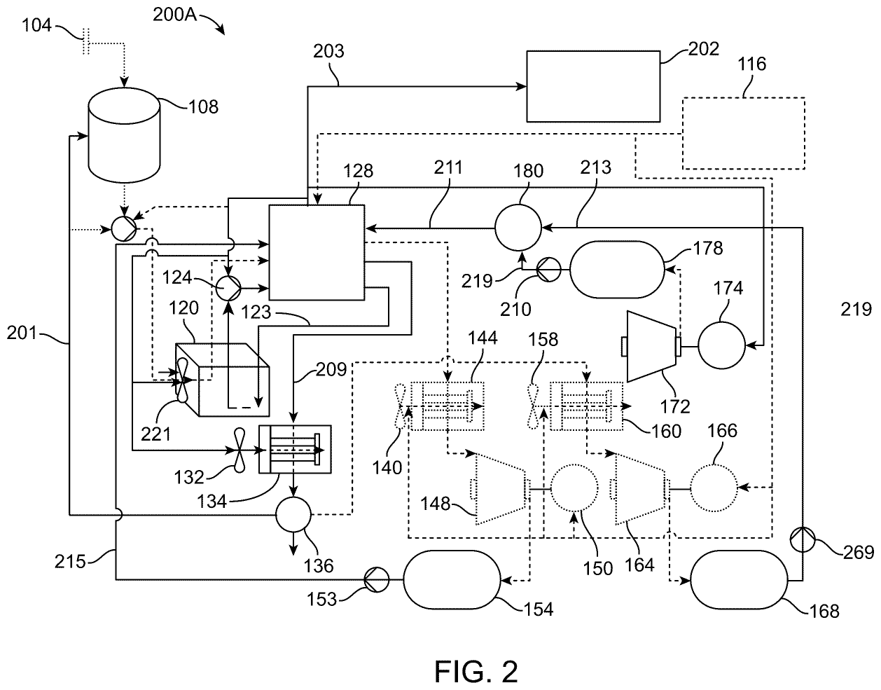

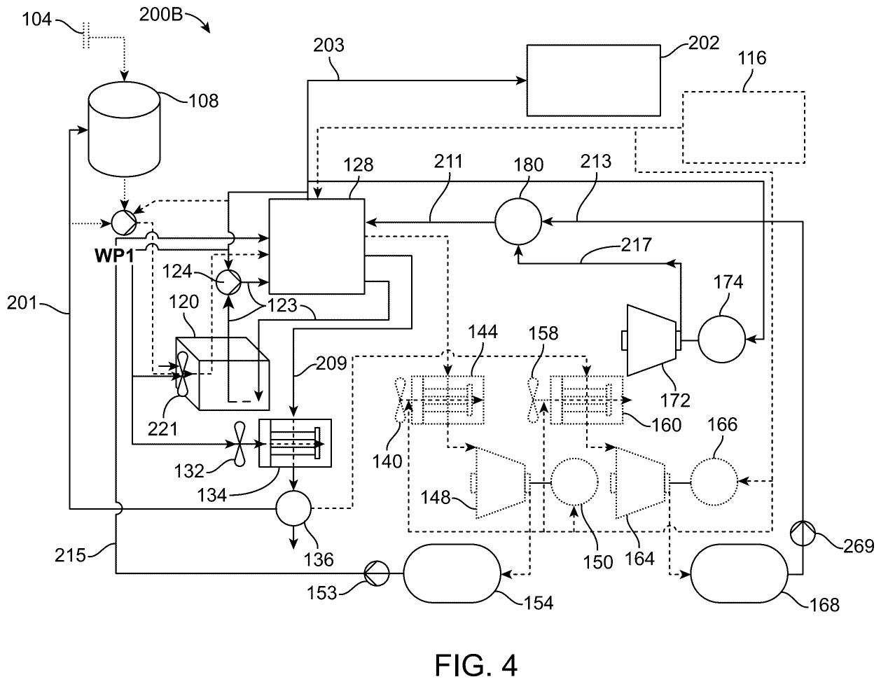

A schematic diagram of components of a system 200A for operating the HTPEM reversible stack 128 in fuel cell mode is shown in FIG. 2. In fuel cell mode, the HTPEM stack 128 generates electricity, consuming hydrogen and an air-oxygen mixture supplied to the anode and cathode of the stack, respectively. Preferably, both reactant streams are pressurized to the same or similar level of pressure. Pressure levels of the reactants are controlled by pressure regulators (e.g., pressure regulator 153 for hydrogen, which sends hydrogen from tank 154 to the anode of HTPEM stack 128 via line 215, pressure regulator 269, which sends oxygen from tank 168 to gas receiver 180 via line 213, and pressure regulator 210, which sends air from tank 178 to gas receiver 180 via line 219). The pressurized air-oxygen mix is sent to the cathode of HTPEM stack 128 via line 211. In an alternative embodiment, in a system 200B shown in FIG. 4, air is supplied from the compressor 172 to the gas receiver 180 directly via line 217 without first being stored in a tank.

Heat produced by the HTPEM stack 128 is removed by recirculating coolant via line 113, which in turn is cooled down at heat exchanger 120 by the flow of ambient air supplied by fan 221. Hot cathode exhaust containing water vapor, nitrogen, and oxygen is carried to heat exchanger 134 via line 209 and cooled to a temperature below 100° C. such that most of the water vapor condenses. Liquid water is separated from the cathode outflow in the separator 136 and directed to the water tank 108 via line 201.

Electric power produced by the stack 128 may be supplied to an external electric power load 202, and may also be used to power the coolant pump 124 and fans 221, 132, as well as electric motor 174 for compressor 172. Inverters and other power electronics managing electric power are not shown on the diagram.

Exemplary operating parameters of the system in the fuel cell mode include HTPEM stack efficiency of 40% to 60%, hydrogen flow stoichiometric ratio of 1.1 to 1.2, cathode flow stoichiometric ratio of 1.3 to 2.0 (preferably 1.4 to 1.6), and absolute pressure of reactants of 2.0 bar to 5.0 bar (preferably, 2.5 bar to 3.0 bar).

The architecture of the system described herein is designed to maximize power output in fuel cell mode by supplying pressurized reactants to the stack, mixing pure oxygen into the cathode air supply, and excluding or minimizing power consumption for cathode air compression. Increasing the power output per stack in this way reduces the cost of the system per kilowatt produced.

Heat generated by the HTPEM stack in the electrolysis mode is used to evaporate water supplied to the stack, and to increase vapor pressure with less use of external power. Using pressurized steam instead of liquid water increases hydrogen output of the stack, eliminates the cost of a water treatment system, and minimizes power consumption for gaseous product compression (the higher the input steam pressure, the higher the pressure of hydrogen and oxygen, keeping all other parameters constant).

The storing of compressed air during electrolysis mode and mixing this air with oxygen for use in fuel cell mode allows for an increase in stack power output due to the increased cathode stoichiometric ratio. It also reduces fuel cell and other material degradation due to reducing oxygen concentration from 100% to 40% to 60%, because pure oxygen is very reactive and can cause accelerated corrosion of fuel cell components. However, partial oxygen concentration is kept at a relatively high (sufficient) level due to the pressure of the gas mixture. That way, the dilution of oxygen does not reduce fuel cell performance, but simultaneously increases the durability of the stack.

Air is compressed in the electrolysis mode instead of compressing it in the fuel cell mode based on the general condition that electric energy is less expensive in periods of the electrolysis mode of operation compared to periods when the system is expected to be in the fuel cell mode. However, a version of the system with a turbo-compressor producing and supplying compressed air in the fuel cell mode instead of using stored air from the pressure vessels is also possible (as in the embodiments shown in FIGS. 3-4).

Various modifications and additions can be made without departing from the spirit and scope of this disclosure. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present disclosure.

What is claimed is:

1. A reversible high temperature proton exchange membrane (HTPEM) system having an electrolysis mode and a fuel cell mode, the system comprising:
an HTPEM reversible fuel cell stack;
a water pump connected to a water supply, wherein the water pump is configured to pressurize liquid water;
a first heat exchanger connected to the water pump and the HTPEM reversible fuel cell stack;
a coolant pump connected to a coolant line, wherein the coolant line loops through the first heat exchanger and the HTPEM reversible fuel cell stack such that, in the electrolysis mode, heat produced in the HTPEM reversible fuel cell stack is transferred to the pressurized liquid water to generate pressurized steam that is supplied to an anode of the HTPEM reversible fuel cell stack;
a second heat exchanger connected to a cathode outlet of the HTPEM reversible fuel cell stack, wherein the second heat exchanger is configured to cool pressurized hydrogen;
a first compressor connected to the second heat exchanger, wherein the first compressor is configured to further compress hydrogen received from the second heat exchanger;
a hydrogen storage tank connected to the first compressor and to the HTPEM reversible fuel cell stack;
a third heat exchanger connected to an anode outlet of the HTPEM reversible fuel cell stack, wherein the third heat exchanger is configured to cool oxygen and water vapor;
a water separator connected to the third heat exchanger configured to condense the water vapor received from the third heat exchanger;
a fourth heat exchanger connected to the water separator, wherein the fourth heat exchanger is configured to cool oxygen received from the water separator;
a second compressor connected to the fourth heat exchanger configured to compress oxygen received from the fourth heat exchanger; and
an oxygen storage tank connected to the second compressor, wherein the oxygen storage tank is connected to the HTPEM reversible fuel cell stack.

2. The system of claim 1, wherein a compressor is not included for the generation of the pressurized steam and wherein the water pump is configured to pressurize liquid water to pressures greater than 2 bar.

3. The system of claim 1, wherein the HTPEM reversible fuel cell stack includes a membrane electrode assembly having an ion conductive electrolyte membrane doped with phosphoric acid, an ion conductive interface layer, a cathode, and an anode, wherein the ion conductive interface layer is between the ion conductive electrolyte membrane and one of the cathode and the anode.

4. A reversible high temperature proton exchange membrane (HTPEM) fuel cell/electrolyzer system having an electrolysis mode and a fuel cell mode, the system comprising:
an HTPEM reversible fuel cell stack;
a water pump connected to a water supply, wherein the water pump is configured to pressurize liquid water;
a first heat exchanger connected to the water pump and the HTPEM reversible fuel cell stack;
a coolant pump connected to a coolant line, wherein the coolant line loops through the first heat exchanger and the HTPEM reversible fuel cell stack such that, in the electrolysis mode, heat produced in the HTPEM reversible fuel cell stack is transferred to the pressurized liquid water to generate pressurized steam that is supplied to an anode of the HTPEM reversible fuel cell stack;
a second heat exchanger connected via a hydrogen line to a cathode outlet of the HTPEM reversible fuel cell stack, wherein the second heat exchanger is configured to cool pressurized hydrogen;
a first compressor connected to the second heat exchanger, wherein the first compressor is configured to further compress hydrogen received from the second heat exchanger;
a hydrogen storage tank connected to the first compressor and to the HTPEM reversible fuel cell stack;
a third heat exchanger connected via an exhaust line to an anode outlet of the HTPEM reversible fuel cell stack, wherein the third heat exchanger is configured to cool oxygen and water vapor from the exhaust line;
a water separator connected to the third heat exchanger, the water supply, and the water pump, wherein the water separator is configured to condense the water vapor received from the third heat exchanger;
a fourth heat exchanger connected to the water separator via an oxygen line, wherein the fourth heat exchanger is configured to cool oxygen received from the water separator;
a second compressor connected to the fourth heat exchanger configured to compress oxygen received from the fourth heat exchanger;
an oxygen storage tank connected to the second compressor; and
a gas receiver connected to the oxygen storage tank and the HTPEM reversible fuel cell stack.

5. The system of claim 4, further including a third compressor configured to receive and compress ambient air and an air tank connected to the third compressor and to the gas receiver.

6. The system of claim 4, further including a first pressure regulator between the hydrogen storage tank and the HTPEM reversible fuel cell stack and a second pressure regulator between the oxygen storage tank and the gas receiver.

7. The system of claim 5, further including a first pressure regulator between the hydrogen storage tank and the HTPEM reversible fuel cell stack, a second pressure regulator between the oxygen storage tank and the gas receiver, and a third pressure regulator between the air tank and the gas receiver.

8. The system of claim 4, wherein the pressurized steam is at pressures of between 2 bar and 4 bar.

9. The system of claim 4, wherein the HTPEM reversible fuel cell stack is electrically connected to the first heat exchanger, the third heat exchanger, and the coolant pump such that, in fuel cell mode, the HTPEM reversible fuel cell stack is configured to supply power to the first heat exchanger, the third heat exchanger, and the coolant pump.

10. The system of claim 4, wherein the first heat exchanger includes a first fan configured to provide air for cooling in the fuel cell mode and wherein the HTPEM reversible fuel cell stack is configured to supply power to the first fan in fuel cell mode.

11. The system of claim 4, wherein a temperature of the coolant is over 130° C. in electrolysis mode.

12. A method of operating a reversible high temperature proton exchange membrane (HTPEM) fuel cell/electrolyzer in an electrolysis mode and a fuel cell mode, comprising:
providing, during the electrolysis mode, pressurized steam to an anode of an HTPEM reversible stack;
electrolyzing the pressurized steam to produce pressurized hydrogen and oxygen at the HTPEM reversible stack;
directing the pressurized hydrogen to a hydrogen storage tank;
cooling a mixture of water vapor and oxygen from an anode outlet;
separating liquid water and the oxygen;
storing the pressurized oxygen to an oxygen storage tank; and
recirculating the liquid water to the anode of an HTPEM reversible stack as pressurized steam.

13. The method of claim 12, further including:
providing, during the fuel cell mode, pressurized hydrogen from the hydrogen storage tank, pressurized oxygen from the oxygen storage tank, and pressurized air to the HTPEM reversible stack;
generating electricity, heat, and water at the HTPEM reversible stack from the pressurized hydrogen and oxygen;
cooling cathode exhaust from the HTPEM reversible stack to form liquid water; and
sending the liquid water to a water tank, wherein the liquid water is used to form the pressurized steam in the electrolysis mode.

14. The method of claim 13, further including:
pressurizing water in a water pump;
passing the pressurized water through a first heat exchanger to produce pressurized steam;
presenting the pressurized steam to an anode of an HTPEM reversible stack;
directing the hydrogen from a cathode outlet to a second heat exchanger to cool the hydrogen;
sending the cooled hydrogen to a compressor to compress the hydrogen;
storing the compressed hydrogen in a hydrogen storage tank;
passing a mixture of water vapor and oxygen from an anode outlet through a third heat exchanger to cool the mixture of water vapor and oxygen;
passing the cooled mixture of water and oxygen to a water separator;
sending the separated water to the water pump when in electrolyzer mode;
sending the separated oxygen to a fourth heat exchanger to cool the oxygen;
sending the cooled oxygen to a compressor; and
sending the compressed oxygen to an oxygen storage tank.

15. The method of claim 14, further including, when in the fuel cell mode:
sending pressurized hydrogen from the hydrogen storage tank to the HTPEM reversible stack;
sending pressurized oxygen from the oxygen storage tank to a gas receiver;
mixing air with the oxygen in the gas receiver;
sending the air and oxygen mixture to the HTPEM reversible stack, wherein the air and gas mixture is pressurized;
sending cathode exhaust from the HTPEM reversible stack to the third heat exchanger for cooling;
sending the cooled cathode exhaust to the water separator to form liquid water and discard air; and
sending the liquid water to a water tank connected to the water pump.

16. The method of claim 15, wherein the steam is pressurized to pressures of between 2 bar and 4 bar when at the HTPEM reversible stack during electrolysis mode.

17. The method of claim 16, wherein an operating temperature of the HTPEM reversible stack is between 130° C. to 270° C.

18. The method of claim 17, wherein the operating temperature of the HTPEM reversible stack is between 140° C. to 200° C.).

19. The method of claim 18, wherein the hydrogen and oxygen flows at the HTPEM reversible stack are at absolute pressures of between 2 bar and 15 bar.

20. The method of claim 19, wherein the hydrogen and oxygen flows at the HTPEM reversible stack are at absolute pressures of between 3.0 bar and 5.5 bar.

21. The method of claim 20, further including compressing air; storing the compressed air in a storage tank; and sending the compressed air to the gas receiver for combining with the oxygen.

22. The method of claim 14, further including providing electrical power from the HTPEM reversible stack during fuel cell mode to one or more of a coolant pump, a fan for the first heat exchanger, a fan for the second heat exchanger, a fan for the third heat exchanger, and a fan for the fourth heat exchanger.

23. The method of claim 12, wherein producing pressurized steam for electrolysis at the HTPEM reversible stack does not include using a compressor.
